(19) United States
(12) Patent Application Publication
(10) Pub. No.: US 2008/0083410 A1
(43) Pub. Date: Apr. 10, 2008

(54) Compact Respiratory Protective Hood

(76) Inventor: Todd A. Resnick, Stuart, FL (US)

Correspondence Address: SMITH HOPEN, PA, 180 PINE AVENUE NORTH, OLDSMAR, FL, 34677, US

(21) Appl. No.: 11/539,960

(22) Filed: Oct. 10, 2006

(51) Int. Cl. A62B 17/04; A62B 18/00

(52) U.S. Cl. 128/201.24; 128/201.22

(57) ABSTRACT

A respiratory protective hood design that aligns rigid components of the respiratory protective hood into a predetermined geometric configuration suitable for a visor to overlay without causing the visor to crease while in the packaged state. An exhalation unit abuts two filtration units on each side to create a substantially uniform surface area over which a visor is disposed while in a packaged state.

### FIELD OF INVENTION

This invention relates to a respiratory protective hood, and more specifically, to a design adapted for compact storage and portability prior to deployment.

### BACKGROUND OF THE INVENTION

Respiratory protective hoods generally cover the head of a person and seal about the neck perimeter. The hood material itself is constructed of a fluid impermeable material and a flexible, transparent integrated visor is affixed about the front of the hood to permit outward vision by the wearer. Inhaled air is filtered for contaminants and exhaled air is discharged from the hood. Applicant's earlier U.S. Pat. Nos. 6,301,103; 6,371,116; 6,701,925; 6,736,137; 6,817,358; 6,907,878; and 7,114,496 provide substantial background discussions on the state of respiratory protective hood design, all of which are incorporated by reference.

A common use for respiratory protective hoods is deployment in unexpected, emergency situations such as terrorist attacks. By its very nature, terrorist attacks are generally executed without warning to the intended victims. Military, police and civilian personnel have little or no notice prior to an attack. These attacks may include the disbursement of nuclear, biological and/or chemical agents with the intent to kill or injure military and/or civilian populations. Accordingly, it is generally not feasible to carry large, protective devices around at all times. A balance must be struck against the real need to have effective protective gear versus the logistics of carrying the protection around on a day-to-day basis.

A solution has been to vacuum pack the respiratory protective hood in a compact form. Packaged units are sealed until they are needed. The outer packaging is opened and the hood is then unfolded deployed. An important objective in many respiratory hood designs is minimizing the package size. This enhances storage and portability of the device and thus directly relates to the device's availability when it is required. However, many attempts to maximize portability and compact design have sacrificed important functional aspects of the device including, but not limited to, outward visibility, protection factor and user comfort.

Maintaining outward vision during normal activities is clearly important. However, in an emergency situation wherein a respiratory protective hood must be deployed, outward vision is critical. Respiratory protective hood visors are preferably not split, hinged or divided which prohibit a wide, uninterrupted field of view. Thus a continuous single panel of a suitable flexible clear material such as 4 mil thick polyester firm is preferred. However, such a large, continuous surface area for the visor requires folding during the packaging of the respiratory protective hood. Folding the visor results in creasing along the folded edges. These creases interfere with the optical properties of the visor and inhibit clear outward vision when the respiratory protective hood is eventually deployed. If the visor is made of a rigid material that does not crease then either the visor must be small with a limited field of view or the package size must be substantially increased thereby limiting the portability and storage options for the device.

What is needed in the art is a respiratory protective hood design that can accommodate a flexible visor having a wide field of view yet can be packaged into a highly compact unit without creasing.

### SUMMARY OF INVENTION

The long-felt but unfulfilled need in the art is met by a design that aligns rigid components of the respiratory protective hood into a predetermined geometric configuration suitable for a visor to overlay without causing the visor to crease while in the packaged state. In one embodiment, an exhalation unit abuts two filtration units on each side to create a substantially uniform surface area over which a visor is disposed while in a packaged state. A folded nose cup is disposed between the two filtration units and the folded nose cup is fluidly coupled to the exhalation unit. Thus, the exhalation unit, the filtration units and the nose cup are all dimensioned so that the visor does not overlay an irregular surface which would crease the visor.

Accordingly, the invention includes a respiratory protective respiratory device having a packaged state and a deployed state. The device includes a fluid impermeable hood sealing a wearer's head about the neck from atmospheric contaminants. A visor is fixed in the hood to permit outward vision by the wearer. A flexible nose cup breathing interface is mounted inside the hood, the cup has an exhalation port and an inhalation port, the inhalation port is fluidly coupled to the interior of the hood. An exhalation unit is fluidly coupled to the exhalation port of the cup whereby air exhaled by the wearer passes through the exhalation unit out the exterior of the hood. Filtration units are disposed on each side of the exhalation unit, each filtration unit fluidly couples the exterior of the hood to the interior of the hood, the filtration units and exhalation unit are dimensioned to abut and at least partially surround the flexible nose cup to create a substantially uniform surface area over which the visor is disposed while in the packaged state.

An interlocking means may be provided to mechanically interconnect the filtration units and exhalation unit while in the packaged state and/or in a deployed state. The interlocking means may include hinges between the exhalation unit and the filtration units thereby permitting the filtration units to articulate upon a common plane while in the deployed state. A harness strap affixed to each filtration unit and partially encircling the rear of wearer's head bias the nose cup against wearer's face. In an embodiment of the invention, the harness strap is affixed to each filtration unit and partially encircles the rear of wearer's head thereby biasing nose cup against wearer's face whereby the mechanical coupling the filtration units and the exhalation unit enable the harness strap to more evenly distribute tension.

Large visors might overlap the ends of the uniform surface area formed by the filtration units and the exhalation unit. Accordingly, an embodiment of the invention provides for the filtration units to have radial edges whereby the visor is not subject to sharp edges that produce creases should it overlap the ends of the substantially uniform surface area formed by the filtration units and exhalation unit. The at least two filtration units and exhalation unit form a U-shape about the folded nose cup and the at least two filtration units, exhalation unit and nose cup are affixed to the interior of the hood.

### BRIEF DESCRIPTION OF THE DRAWINGS

For a fuller understanding of the invention, reference should be made to the following detailed description, taken in connection with the accompanying drawings, in which:

FIG. 1 is an elevated perspective view of the folded nose cup, exhalation and filtration units in a packaged configuration.

FIG. 2 is an elevated perspective view of the exhalation and filtration units in a deployed configuration and the folded nose cup in a packaged configuration.

FIG. 3 is an elevated perspective view of the exhalation and filtration units in a deployed configuration showing an unfolded nose cup breathing interface.

FIG. 4 is a partially sectional, elevated perspective view from the rear interior of the hood of the exhalation and filtration units in a deployed configuration showing an unfolded nose cup breathing interface in relation to the respiratory protective hood and visor.

FIG. 5 is a top-down, partially sectional view of an embodiment of the invention in a packaged state showing the nose cup in a folded configuration between the two filtration units and the exhalation unit.

FIG. 6 is a top-down, partially sectional view of an embodiment of the invention in a deployed state showing the nose cup in an unfolded configuration and the two filtration units angled away from the exhalation unit on hinges.

FIGS. 7A-B are elevated, perspective views of an embodiment of the invention in a packaged state showing the visor overlapping radial edges of the filtration units thereby avoiding sharp angles that crease the visor.

FIG. 8 is a partially sectional, elevated side view of an embodiment of the invention is a deployed state showing the movement of the visor from its packaged position to its deployed position. Additionally, the unfolding direction of the nose cup from its packaged state to its deployed state is also shown.

FIG. 9 is a partially sectional, top-down elevated view of an embodiment of the invention showing the fluid pathway of the device's configuration.

FIG. 10 is a partially sectional, top-down elevated view of an embodiment of the invention showing the harness straps used to bias the nose cup against the face of the wearer.

FIGS. 11A-D are elevated views of a nose cup folding method according to the present invention.

FIG. 12 is a partially sectional, top down elevated view of an embodiment of the invention in a packaged state utilizing a slide mechanism for separating the filtration units from the exhalation units.

FIG. 13 is a partially sectional, top down elevated view of an embodiment of the invention in a deployed state utilizing a slide mechanism for separating the filtration units from the exhalation units.

### DETAILED DESCRIPTION OF THE PREFERRED EMBODIMENT

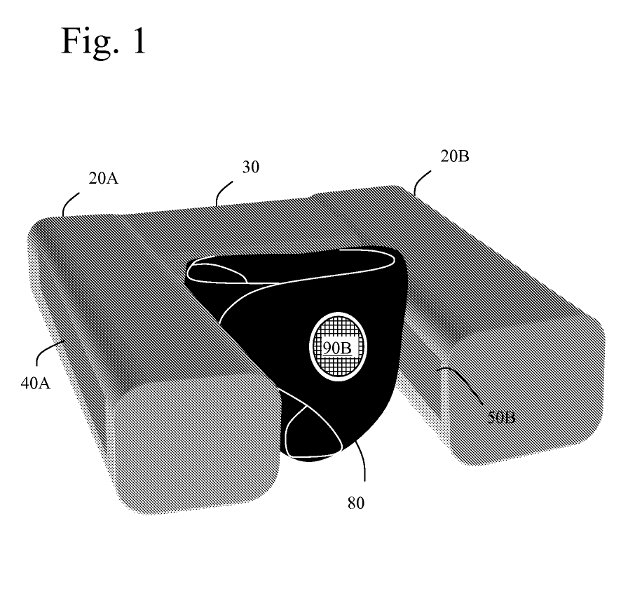

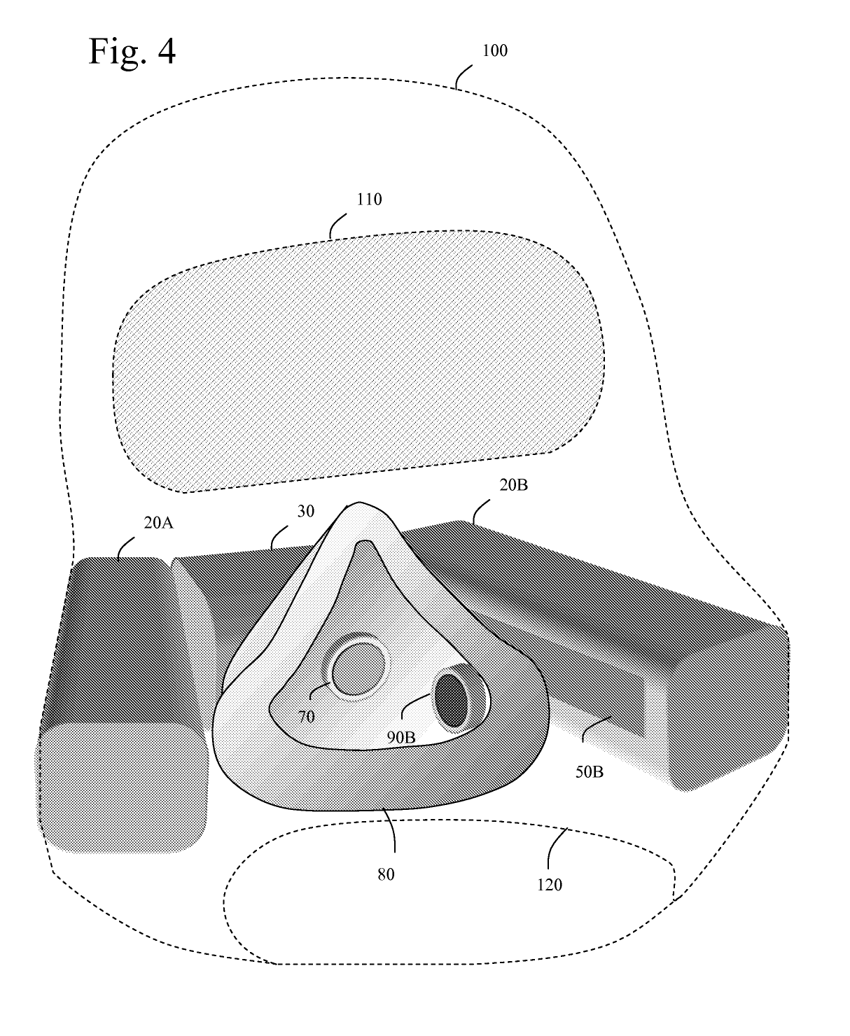

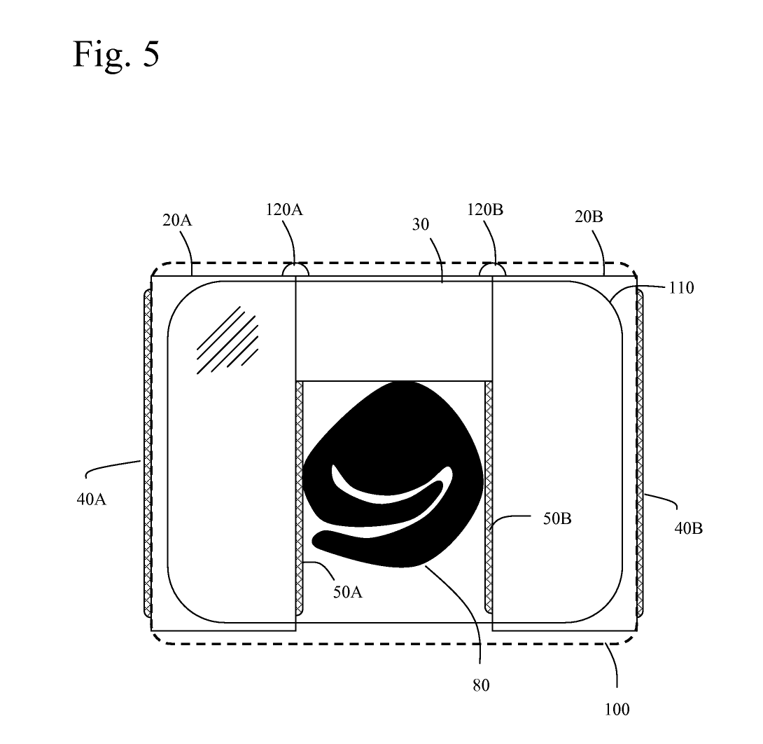

Turning to FIG. 1, exhalation unit 30 and filtration unit 20A-B form a U-shaped platform around folded nose cup 80. Nose cup 80 in an unfolded state is generally triangular with a nose bridge at the top and lower, lateral extensions that cover either side of the wearer's mouth. In the embodiment shown, the top nose bridge is first folded downward then each lateral extension is folded to the center so that nose cup 80 fits within the U-shape void. Inhalation valve 90B is shown on the right lateral extension of nose cup 80. Another valve, inhalation valve 90A is on the left lateral extension (not shown due to folded configuration of nose cup 80). Nose cup 80 is fluidly coupled to exhalation unit 30 which encloses an exhalation check valve (not shown) to prevent inhalation of unfiltered air. Exhalation unit 30 preferably also includes a baffled purge zone that reduces or prevents contaminated air from reaching and challenging exhalation valve 145. For simplicity, the hood and visor are not shown in FIG. 1 so that the internal components are viewable. However, inlet opening 40A on filtration unit 20A is either external or flush with the hood outer layer. Ambient, contaminated air passes through inlet opening 40A and passes through filtration unit 20A to remove contaminates before passing through exit opening 50A (FIG. 5) to the interstitial space within hood 100 (FIG. 4). An advantage of this embodiment of the invention is that the elongated surface area of inlet grid 40A and exit grid 50A reduce breathing resistance and thus enhance long-term comfort and wearability. In addition, introducing fresh, filtered area into the interstitial space within the hood helps keep the hood cooler and reduces moisture accumulation. As the wearer inhales, the filtered air in the interstitial space passes through inhalation valves 90A and 90B located on the lateral sides of nose cup 80. Inhalation valves 90A and 90B have integrated check valves thereby permitting only fluid flow from the interstitial space within the hood to nose cup 80. Exhaled air within nose cup 80 is blocked from entering the interstitial space within the hood by the check valves.

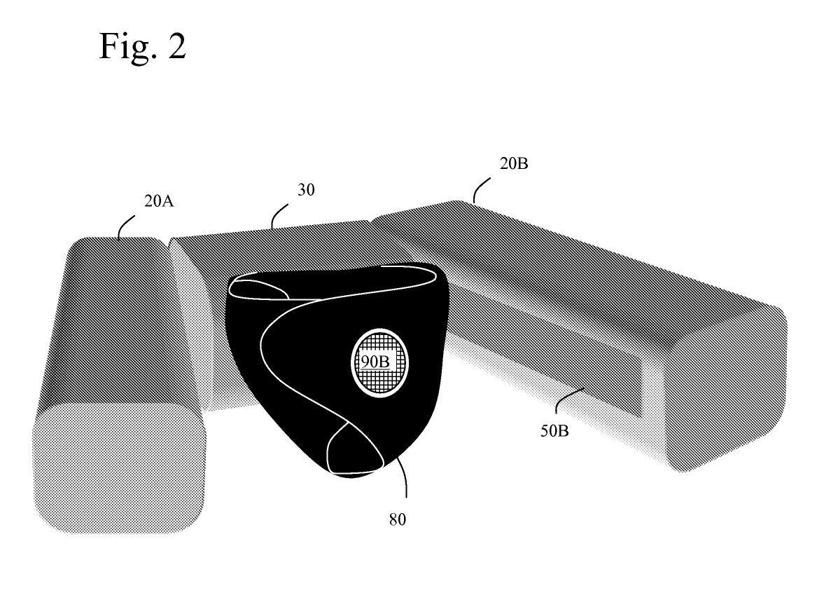

In FIG. 2, the invention is partially deployed. Nose cup 80 is still in a folded configuration but filtration units 20A-B are angled away from exhalation unit 30 thereby widening the void created by the U-shaped configuration of the packaged state. Exit opening 50B may extend the length of filtration unit 20B. Therefore, when filtration unit 20B is angled away from exhalation unit 30, more surface area of exit opening 50B is exposed to the interior of the hood thus lowering breathing resistance.

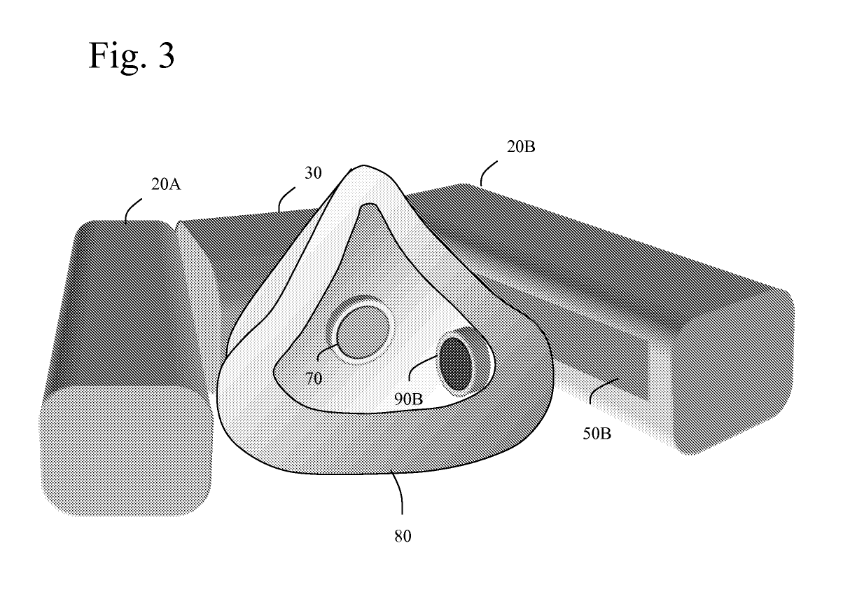

In FIG. 3, the invention is in a full deployed where wherein nose cup 80 has unfolded to its normal state, ready to engage the face of the wearer for respiration. Inhalation valve 90B is visible from within the interior of nose cup 80 and exhalation aperture 70 is fluidly coupled to exhalation unit 30. In FIG. 4, nose cup 80, filtration units 20A-B and exhalation unit 30 are presented in relation to a cross-section of respiratory protective hood 100 as viewed from the rear of the hood looking forward through visor 110. Neck aperture 120 accepts the head of the wearer and fluidly seals about the neck via an elastomeric interface.

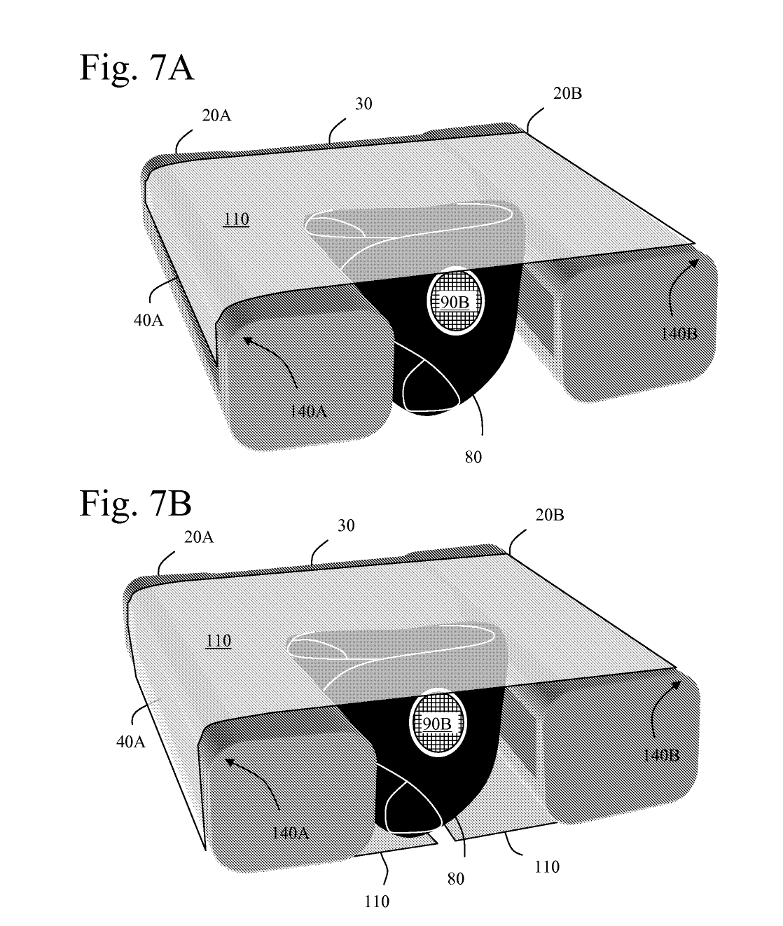

FIG. 5 is a top-down view of an embodiment of the invention in a packaged state showing nose cup 80 in a folded configuration. Hood 100 is seen in a cross section whereby inlet opening 40A-B are exterior to the hood surface. In this embodiment, filtration units 20A-B are pivotably connected to exhalation unit 30 via hinges 120A-B. An advantage of hinges 120A-B is that they make aligning filtration units 20A-B and exhalation unit 30 simple for packaging and creating a uniform surface for overlaying visor 110. Visor 110 is shown on top of filtration units 20A-B, exhalation unit 30 and folded nose cup 80. In this embodiment, visor 110 does not overlap the outer lateral edges of filtration units 20A-B. However, in alternative embodiments (FIGS. 7A-B) overlap can be achieved within the scope of the invention.

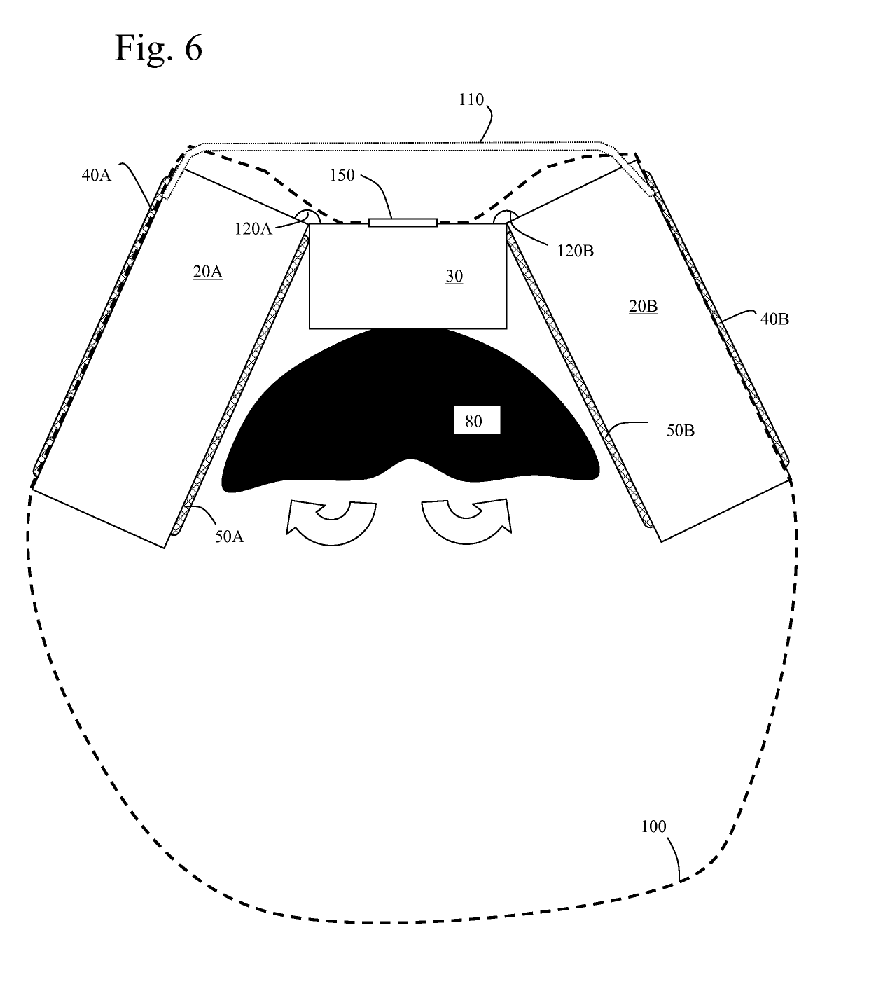

In FIG. 6, visor 110 is tilted upwards away from the uniform surface area created by the alignment of filtration units 20A-B, exhalation unit 30 and folded nose cup 80. Filtration units 20A-B pivot on hinges 120A-B away from exhalation unit 30. The lateral edges of nose cup 80 unfold outward and the nasal bridge of nose cup 80 unfolds upwards whereby nose cup 80 is in its deployed state. It is seen that exit openings 50A-B open to the interstitial space within hood 100 and their disengagement from abutting exhalation unit 30 gives exit openings 50A-B more surface area exposure to the interstitial space of hood 100. Exhaled air is discharged out exhalation port 150 from exhalation unit 30 to the exterior of hood 100.

In FIG. 7A, visor 110 is shown overlapping radial edges 140A-B of filtration units 20A-B respectively. The radial edges permit visor 110 to be larger than a single planer surface produced by abutting filtration units 20A-B, exhalation unit 30 and folded nose cup 80. In FIG. 7B, it is shown that radial edges 140A-B extend about at least two longitudinal sides of filtration units 20A-B whereby visor 110 encircles a single axis of the geometric configuration formed by the abutment of filtration units 20A-B, exhalation unit 30 and folded nose cup 80. It is important to note that visor 110 can only fold about a single axis. Folding on more than one substantially perpendicular axis will produce creasing in visor 110 regardless of the use of axial edges.

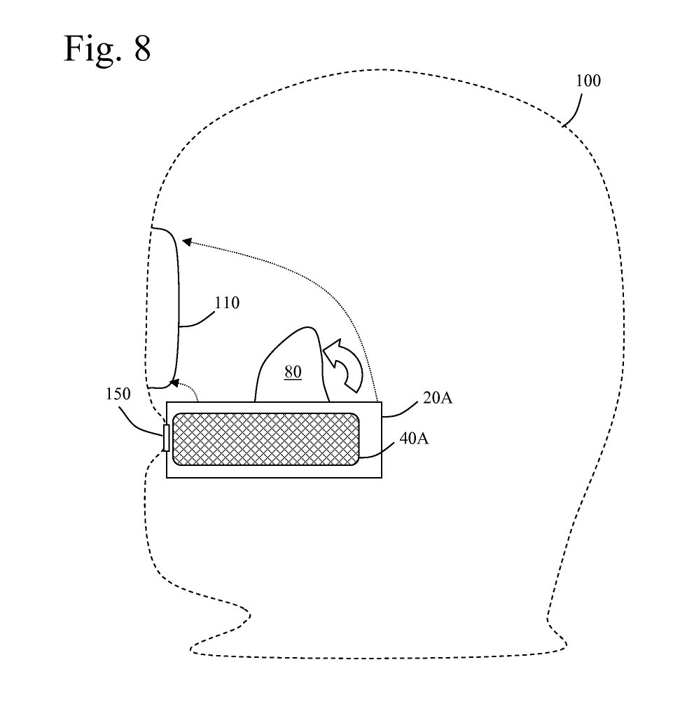

In FIG. 8, a partially section view of hood 110 is viewable with the movement of visor 110 shown from the top of filtration unit 20A to its deployed state on a vertical plane. The unfolding direction nasal bridge of nose cup 80 is also shown. It should be noted that inlet opening 40A is external to hood 100 while the rest of filtration unit 20A is within the interior of hood 100. In an alternative embodiment, the filtration units may also be affixed external to the hood or partially integrated therein.

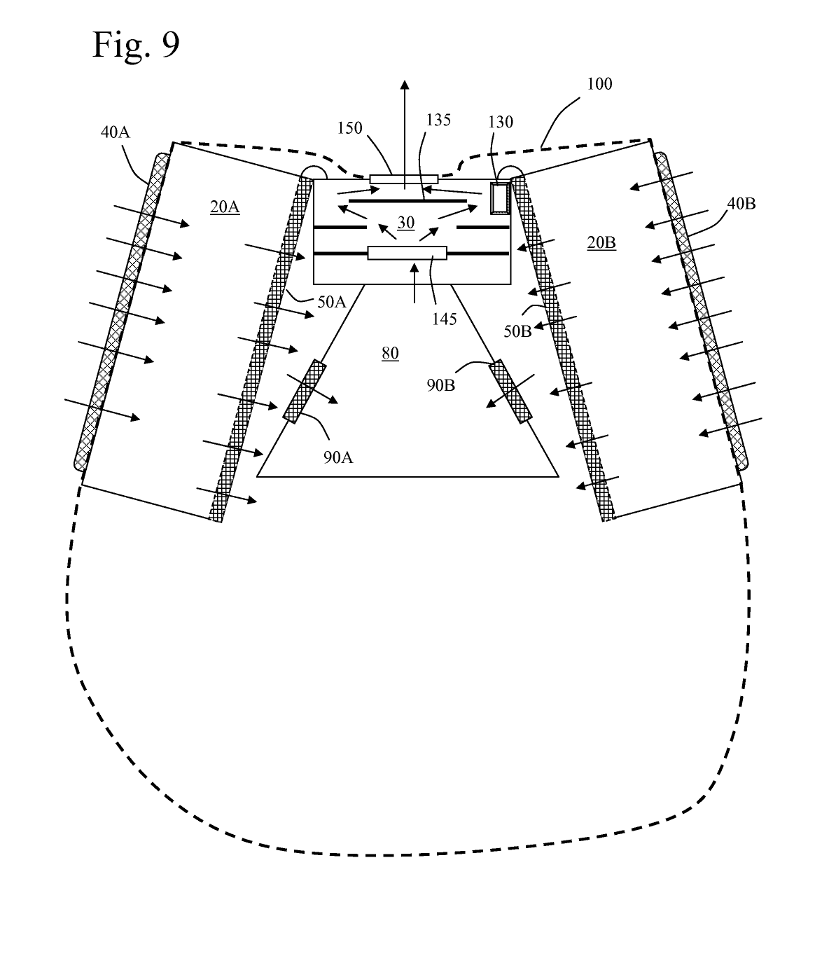

FIG. 9 illustrates the air pathway of an embodiment of the invention wherein ambient air is first drawn through inlet openings 40A-B which are substantially integral to the surface area of hood 100. Air is filtered through filtration units 20A-B before passing through exit openings 50A-B to the interstitial space within the interior of hood 100. Inhalation valves 90A-B draw filtered into nose cup 80 which is respired and exhaled out to exhalation unit 30. Baffles create a convoluted pathway in exhalation unit 30 to establish a purge zone. Exhaled air is discharged out exhalation port 150 to the exterior of hood 100. A radio frequency identification chip 130 is affixed to exhalation unit 30. A combination baffle-voice transmitter membrane 135 is integral to exhalation unit 30. Exhalation valve 145 permits one-way airflow from nose cup 80 through exhalation unit 30 and out exhalation port 150.

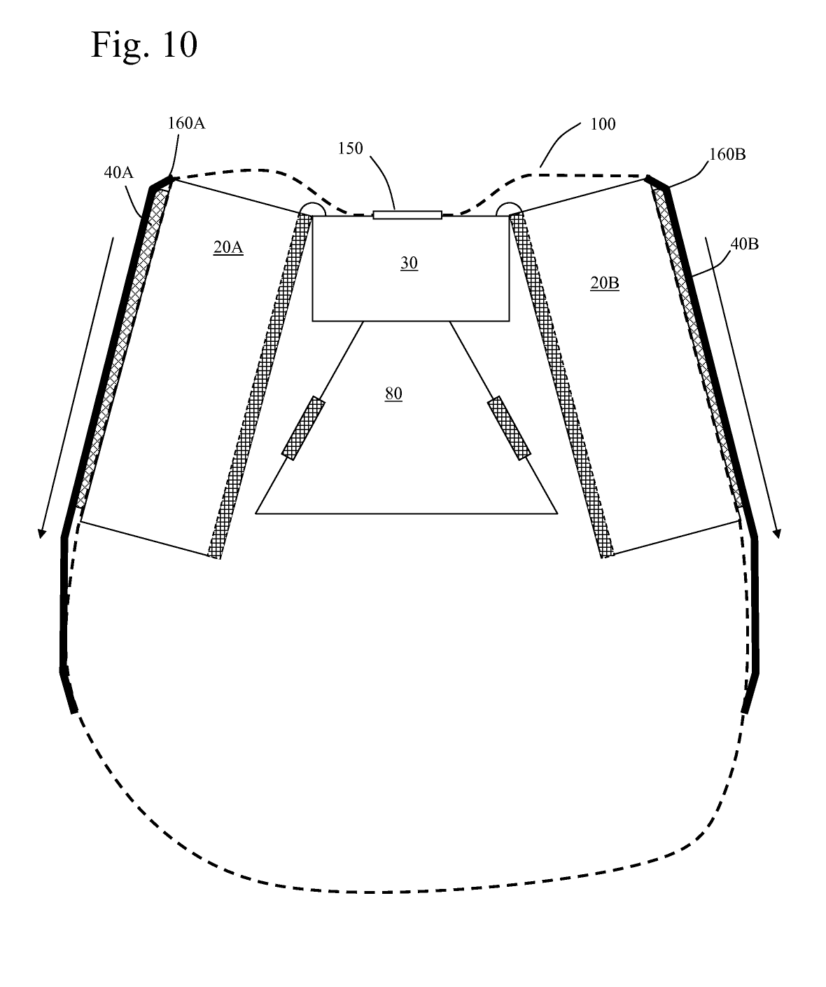

In FIG. 10, an embodiment of the invention incorporates harness straps to bias nose cup 80 against the face of the wearer (not shown). An advantage of mechanically coupling filtration units 20A-B and exhalation unit 30 together is the straps provide a more even distribution of force when connected to filtration units 20A-B.

It should be noted that alternative embodiments within the scope of the present invention do not require or mandate that filtration units 20A-B and exhalation unit 30 be mechanically coupled at all. However, it is preferred that at least while in the packaged state, some form of positive engagement is provided whereby filtration units 20A-B, exhalation unit 30 and folded nose cup 80 all align to form a uniform surface area upon which visor 110 overlays to avoid creasing while maintaining a highly compact packaged state.

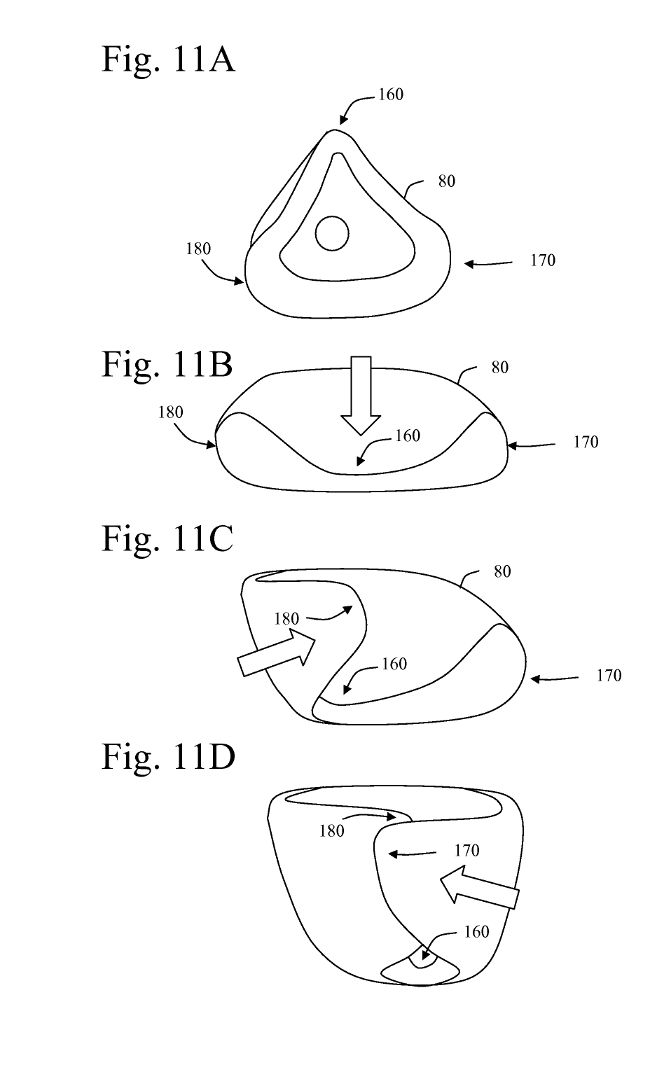

A folding method according to an embodiment of the invention is provided in FIGS. 11A-D. As noted above, nose cup 80 is generally triangular-shaped having a nose bridge 160, a left lateral extension 180 and a right lateral extension 170 (FIG. 11A). Nose bridge 160 is folded downward (FIG. 11B). Either lateral extension (left lateral extension 180 in this example) is folded inward over the folded nose bridge 160. Finally, the remaining later extension (right lateral extension 170 in this example) is folded inward to either abut or overlap left lateral extension 180 thereby forming highly compact folded nose cup 80.

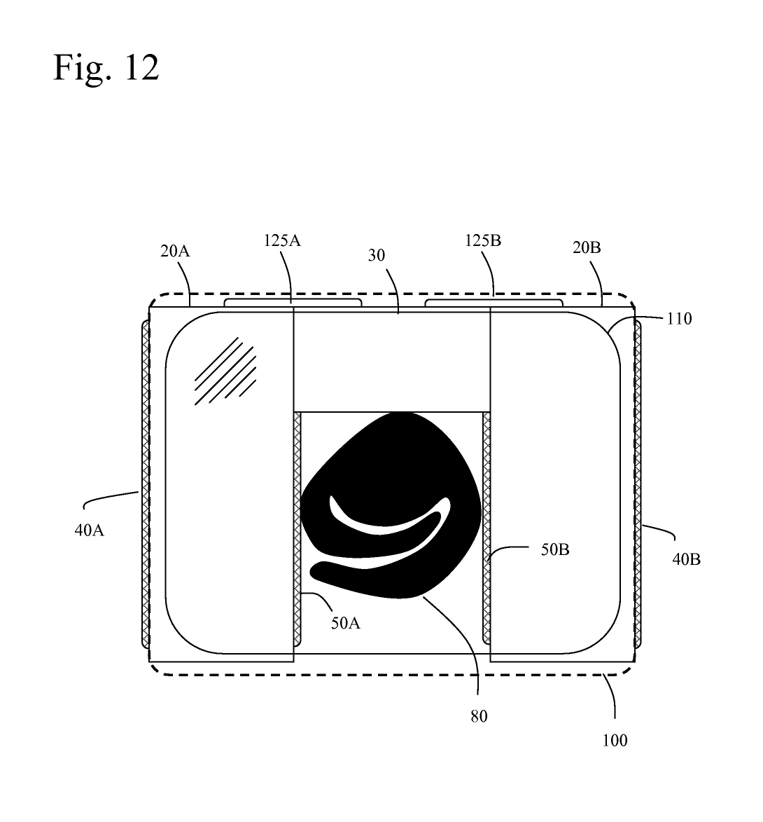

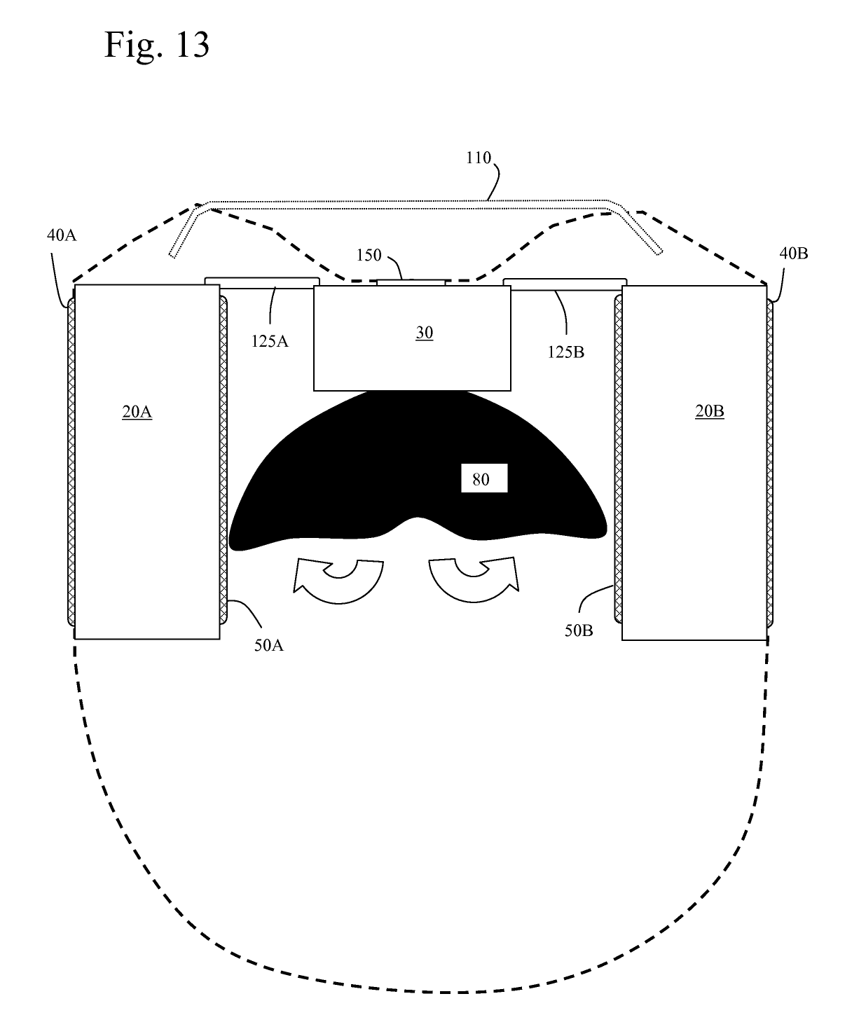

In FIGS. 12-13 an alternative embodiment of the invention is presented wherein filtration units 20A-B are slideably coupled to exhalation unit 30 whereby upon deployment, filtration units 20A-B laterally expand away from exhalation unit 30 and nose cup 80 unfolds.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween. Now that the invention has been described,

What is claimed is:

1. An exhalation unit abutting at least two filtration units to create a substantially uniform surface area over which a visor is disposed while in a packaged state.

2. The apparatus of claim 1 further comprising a folded nose cup disposed between the at least two filtration units, the folded nose cup fluidly coupled to the exhalation unit.

3. A respiratory protective device having a packaged state and a deployed state, the device comprising:
a hood sealing a wearer's head about the neck from atmospheric contaminants;
a visor fixed in the hood to permit outward vision by the wearer;
a flexible nose cup breathing interface inside the hood, the cup having an exhalation port and an inhalation port, the inhalation port fluidly coupled to the interior of the hood;
an exhalation unit fluidly coupled to the exhalation port of the cup whereby air exhaled by the wearer passes through the exhalation unit out the exterior of the hood; and
filtration units disposed on each side of the exhalation unit, each filtration unit fluidly coupling the exterior of the hood to the interior of the hood, the filtration units and exhalation unit dimensioned to abut and at least partially surround the flexible nose cup to create a substantially uniform surface area over which the visor is disposed while in the packaged state.

4. The hood of claim 3 further comprising an interlocking means to mechanically interconnect the filtration units and exhalation unit while in the packaged state.

5. The hood of claim 4 wherein the interlocking means is maintained in the deployed state.

6. The hood of claim 5 wherein the interlocking means comprises hinges between the exhalation unit and the filtration units thereby permitting the filtration units to articulate upon a common plane while in the deployed state.

7. The hood of claim 5 wherein the interlocking means comprises slides between the exhalation unit and the filtration units thereby permitting the filtration units to extend upon a common plane while in the deployed state.

8. The hood of claim 3 further comprising a harness strap affixed to each filtration unit and partially encircling the rear of wearer's head thereby biasing nose cup against wearer's face.

9. The hood of claim 6 further comprising a harness strap affixed to each filtration unit and partially encircling the rear of wearer's head thereby biasing nose cup against wearer's face whereby the mechanical coupling the filtration units and the exhalation unit enable the harness strap to more evenly distribute tension.

10. The hood of claim 7 further comprising a harness strap affixed to each filtration unit and partially encircling the rear of wearer's head thereby biasing nose cup against wearer's face whereby the mechanical coupling the filtration units and the exhalation unit enable the harness strap to more evenly distribute tension.

11. A respiratory protective hood comprising an exhalation unit abutting at least two filtration units, the exhalation unit and at least two filtration units dimensioned to create a substantially uniform surface area over which a visor is disposed while in a packaged state, a folded nose cup fluidly coupled to the exhalation unit and disposed between the at least two filtration units.

12. The hood of claim 11 wherein the filtration units and exhalation unit have radial edges whereby the visor is not subject to sharp edges that produce creases should it overlap the ends of the substantially uniform surface area formed by the filtration units and exhalation unit.

13. The hood of claim 11 wherein the at least two filtration units and exhalation unit form a U-shape about the folded nose cup.

14. The hood of claim 11 wherein the at least two filtration units, exhalation unit and nose cup are affixed to the interior of the hood.

15. The hood of claim 11 wherein the folded nose cup comprises a top nose bridge, a left lateral extension and a right lateral extension whereby in a packaged state, top nose bridge is folded downward and overlapped by left and right lateral extensions which are folded inward over folded-down top nose bridge thereby forming a compact configuration.
